(19) United States
(12) Patent Application Publication
(10) Pub. No.: US 2006/0069948 A1
(43) Pub. Date: Mar. 30, 2006

(54) Error detecting memory module and method

(76) Inventors: Jong-Cheol Seo, Gyeonggi-do (KR); Byung-Se So, Gyeonggi-do (KR); Young-Man Ahn, Gyeonggi-do (KR)

Correspondence Address: MARGER JOHNSON & McCOLLOM, P.C., 1030 S.W. Morrison Street, Portland, OR, 97205, US

(21) Appl. No.: 11/181,059

(22) Filed: Jul. 13, 2005

(30) Foreign Application Priority Data
Sep. 9, 2004 (KR) 2004-72105

(51) Int. Cl. G06F 11/00

(52) U.S. Cl. 714/6

(57) ABSTRACT

We describe and claim an error detecting memory module and method. The module comprises a plurality of memory devices, each memory device to receive an address signal and a command signal from a memory controller, and to detect an error in the address and command signals responsive to an input parity signal. In an embodiment, each memory device is adapted to provide an output parity signal to the memory controller responsive to the detection.

### BACKGROUND OF THE INVENTION

This application claims the priority of Korean Patent Application No. 10-2004-0072105 filed on Sep. 9, 2004, which we incorporate by reference.

1. Field of the Invention

The field of the invention relates to a semiconductor device, and more particularly, to a memory module.

2. Description of the Related Art

A typical memory module includes a plurality of memory devices to store data and a circuit to detect, and optionally to correct, errors in the data to be stored. A master device, or memory controller, controls access to the memory devices through command and address signals. The signals, however, may be corrupted during transmission to the memory module, e.g. by transmission through imperfect transmission lines, and thus fail to control the memory module properly.

Systems requiring a large memory capacity, such as work stations, typically include a plurality of memory modules. The above-recited problem, however, multiplies when the number of the memory modules increases or the operational speed of the system increases. One approach used to advert the failures is to incorporate a buffer to detect and correct signal errors into each memory module within the system. Each buffer may also detect or correct errors in data to be stored. The work station buffers are serially connected, where a buffer in a first memory module receives signals from the master device, detects and corrects transmission errors when present, and transmits the corrected signal to a buffer within a second memory module. The buffer in the first module also provides the corrected signal to the memory devices within the first memory module. Additionally to reduce potential transmission errors, work stations may reduce the transmission amplitude of signals. Thus, each buffer may amplify a received signal, as well as detect and correct errors in the signal.

A memory module used in a system that does not require large memory capacity, such as a personal computer, does not include the buffer, and thus cannot detect errors in signals transmitted from the master device. Accordingly a need remains for an improved error detecting memory module and method.

### SUMMARY OF THE INVENTION

The present invention provides an error detecting memory module to detect an error of a command signal or an address signal. The module comprises a plurality of memory devices, each memory device to receive an address signal and a command signal from a memory controller, and to detect an error in the address and command signals responsive to an input parity signal. In an embodiment, each memory device is adapted to provide an output parity signal to the memory controller responsive to the detection.

### BRIEF DESCRIPTION OF THE DRAWINGS

The features and advantages of the present invention will become more apparent with a detailed description of the embodiments referencing the attached drawings.

FIG. 1 is a block diagram showing a memory module according to the present invention.

FIG. 2 is a block diagram of an embodiment of a memory device shown in FIG. 1.

FIG. 3 illustrates an example operational mode of a mode register shown in FIG. 2.

FIG. 4 illustrates another example operational mode of the mode register shown in FIG. 2.

FIG. 5 is a block diagram of another embodiment of a memory device shown in FIG. 1.

FIG. 6 is a block diagram showing a memory module according to another embodiment of the present invention.

### DETAILED DESCRIPTION OF THE INVENTION

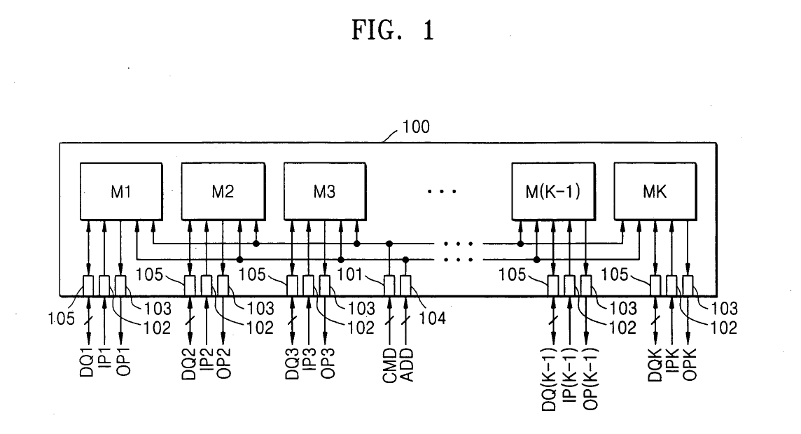

FIG. 1 is a block diagram showing a memory module 100 according to an embodiment of the present invention. Referring to FIG. 1, the memory module 100 includes a plurality of memory devices M1˜MK, at least one first tab 101, a plurality of second tabs 102, a plurality of third tabs 103, at least one fourth tab 104, and a plurality of fifth tabs 105. Although, the memory module 100 is shown to include one first tab 101 and one fourth tab 104, in other embodiments the memory module 100 may include a plurality of first tabs 101 and/or a plurality of fourth tabs 104.

Each of the plurality of memory devices M1˜MK couples to the first tab 101, the fourth tab 104, and to a corresponding second tab 102, third tab 103, and fifth tab 105. The plurality of memory devices M1˜MK receive a command signal CMD through the first tab 101, an address signal ADD through the fourth tab 104, and input parity signals IP1˜IPK through the plurality of second tabs 102. Each memory device M1˜MK detects an error of the command signal CMD and the address signal ADD in response to a corresponding input parity signal IP1˜IPK, and provides a corresponding output parity signal OP1˜OPK to an external master device (not shown) through the plurality of third tabs 103 responsive to the detection. Upon reception of at least one output parity signal OP1˜OPK, the external master device determines an error occurred during transmission of the command signal CMD and the address signal ADD. Each memory device M1˜MK transfers data signals DQ1˜DQK through the fifth tabs 105 in response to the command signal CMD and the address signal ADD. In some memory systems, the first through fifth tabs 101˜105 may perform the same functions of memory device signal pins.

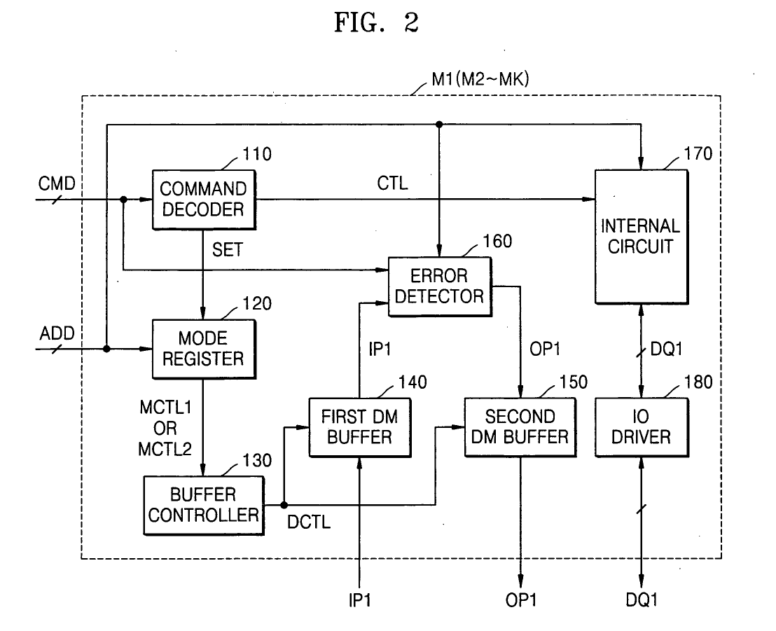

FIG. 2 is a block diagram of an embodiment of the memory device M1 shown in FIG. 1. Memory devices M2˜MK operate similarly to memory device M1. Referring to FIG. 2, the memory device M1 includes a command decoder 110, a mode register 120, a buffer controller 130, a first and a second data masking (DM) buffers 140 and 150, an error detector 160, an internal circuit 170, and an input/output (I/O) driver 180. The command decoder 110 provides an internal controller signal CTL to internal circuit 170 and a setting control signal SET to mode register 120, in response to the command signal CMD. An external master device exchanges data signals DQ1 with internal circuit 170 through I/O driver 180 responsive to internal control CTL and address signal ADD. The mode register 120 stores an address signal ADD in response to the setting control signal SET, and provides a mode control signal MCTL1 or MCTL2 to buffer controller 130 responsive to the address signal ADD. The mode register 120 provides the mode control signal MCTL1 in a mode register set (MRS) mode and provides the mode control signal MCTL2 in an extended mode register set (EMRS) mode, where the mode is determined according to the address signal ADD.

The buffer controller 130 provides a buffer control signal DCTL to the first and second DM buffers 140 and 150 in response to the mode control signal MCTL1 or MCTL2. The first and second DM buffers 140 and 150 operate in a data masking (DM) mode or an error detecting mode in response to the buffer control signal DCTL. In error detection mode, the first DM buffer 140 receives an input parity signal IP1, and provides the received input parity signal IP1 to the error detector 160. The second DM buffer 150 receives the output parity signal OP1 from the error detector 160, and provides the received output parity signal OP1 to the external master device. Although not shown in FIG. 2, in DM mode, the first and second DM buffers 140 and 150 may mask the data to be stored in the memory device M1 in response to DM control signals received through second and third tabs 102 and 103. Since the memory device M1 receives the input parity signal IP1 through the first DM buffer 140 and provides the output parity signal OP1 through the second DM buffer 150, the memory device M1 does not require additional input/output circuits for input parity signal IP1 and the output parity signal OP1, or additional tabs for the additional input/output circuits.

The error detector 160 determines whether an error is present in the command signal CMD and the address signal ADD responsive to the input parity signal IP1, and provides the output parity signal OP1 to second DM buffer 150 responsive to the determination. For instance, when the command signal CM1 includes a plurality of commands and the address signal ADD includes a plurality of addresses, the master device may enable or disable the input parity signal IP1 according to the number of commands and addresses present in the command signal CMD and address signal ADD, respectively. In an embodiment, when the number of commands and addresses is an even number, the master device may disable the input parity signal IP1, and when the number of commands and the addresses is an odd number, the master device may enable the input parity signal IP1. In another embodiment, the error detector 160 may enable the output parity signal OP1 when the sum of commands in the command signal CMD, addresses in the address signal ADD, and the input parity signal IP1 is even, and may disable the output parity signal OP1 when the sum is odd.

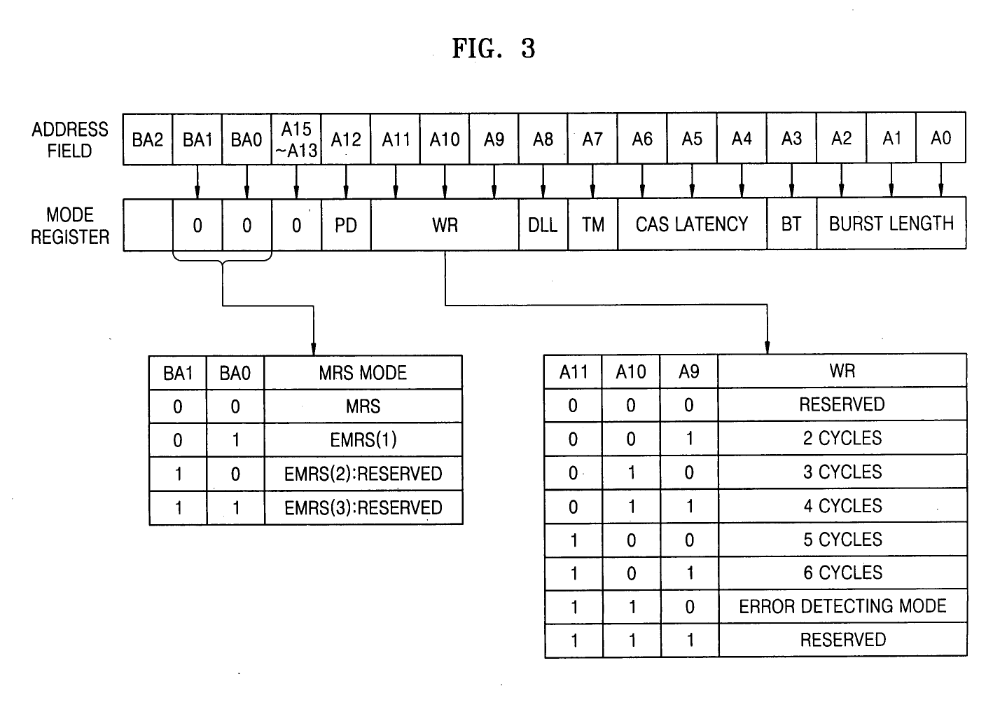

FIG. 3 illustrates an example operational mode of the mode register 120 shown in FIG. 2. The mode register 120 operates in the MRS mode in FIG. 3. Referring to FIG. 3, the mode register 120 performs operations according to the values of address fields BA0˜BA2, A0˜A15. For example, fields BA0˜BA2 indicate operation in a MRS mode or EMRS mode. Fields A0˜A2 specify the burst length. Field A3 specifies the burst type (BT). Fields A4˜A6 specify a CAS latency. Field A7 indicates operation in a test mode TM. Field A8 specifies a DLL reset. Fields A9˜A11 specify a write mode, including an error detection mode. Field A12 specifies an active power down exit time. Fields A13˜A15 are reserved address fields, each set to “0”. As shown in FIG. 3, when fields A11˜A9 are “110”, the mode register 120 operates in an error detection mode. The mode register 120 may further operate in error detection mode when fields A11˜A9 specify a reserved operation, e.g., “000” or “111”.

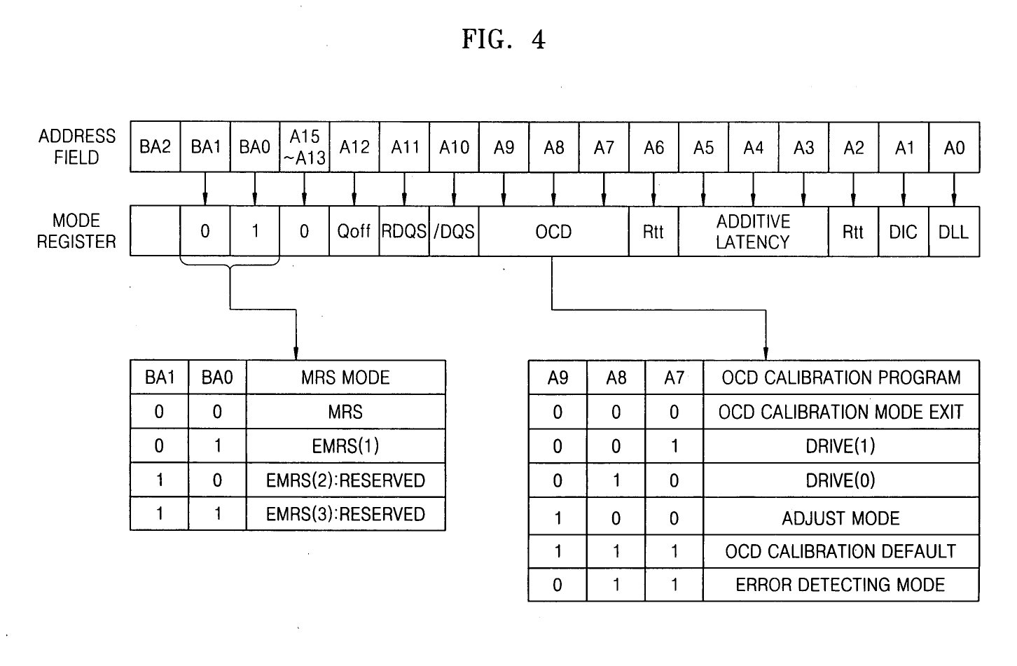

FIG. 4 illustrates another example operational mode of mode register 120 shown in FIG. 2. In FIG. 4, the mode register 120 operates in the EMRS mode. Referring to FIG. 4, the mode register 120 performs operations according to the values set by the address fields BA0˜BA2, A0˜A15. For example, fields BA˜BA2 indicate operation in MRS mode or EMRS mode. Field A0 specifies a DLL reset operation. Field A1 specifies an impedance of the output driver. Fields A2 and A6 specify an on die termination (ODT). Field A1 specifies an additive latency. Fields A7˜A9 indicate an off chip driver (OCD) impedance or the operation in an error detection mode. Fields A10˜A11 specify a strobe function. Field A12 specifies operations of an output buffer. Fields A13˜A15 are reserved address fields, each set to “0”. As shown in FIG. 4, when fields of A9˜A7 are “011”, the mode register 120 operates of the error detection mode. The mode register 120 may further operate in the error detection mode when fields A9˜A7 specify a reserved operation, e.g., “110” or “101”.

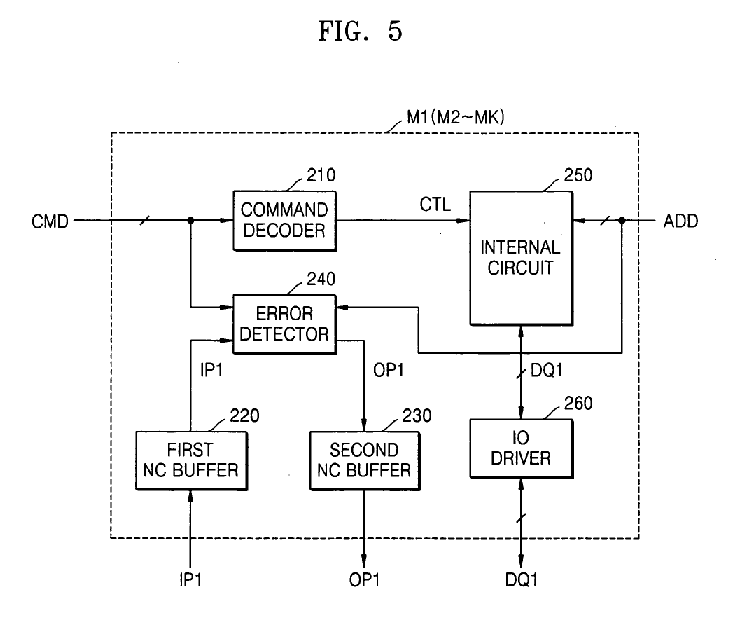

FIG. 5 is a detailed block diagram of another embodiment of a memory device M1 shown in FIG. 1. Memory devices M2˜MK operate similarly to memory device M1. Referring to FIG. 5, the memory device M1 includes a command decoder 210, a first and a second no connecting (NC) buffers 220 and 230, an error detector 240, an internal circuit 250, and an I/O driver 260. The command decoder 210 provides an internal control signal CTL to internal circuit 250 in response to the command signal CMD. An external master device exchanges data signals DQ1 with internal circuit 250 through IO driver 260 in response to the internal control signal CTL and address signal ADD. The first NC buffer 220 receives the input parity signal IP1 and provides the received input parity signal IP1 to the error detector 240. The second NC buffer 230 receives the output parity signal OP1 from the error detector 240, and provides the received output parity signal OP1 to the external master device. The first and second NC buffers 220 and 230 may be spare buffers included in memory device M1. As described above, since the memory device M1 receives the input parity signal IP1 through the first NC buffer 220 and outputs the output parity signal OP1 through the second NC buffer 230, the memory device M1 does not need to include additional input/output circuits for inputting/outputting the input parity signal IP1 and the output parity signal OP 1, or additional tabs for the additional input/output circuits.

The error detector 240 determines whether an error is generated in the command signal CMD and the address signal ADD responsive to the input parity signal IP1, and provides the output parity signal OP1 to the second NC buffer 230 according to the determination. The detailed operation of error detector 240 may be similar to that of error detector 160.

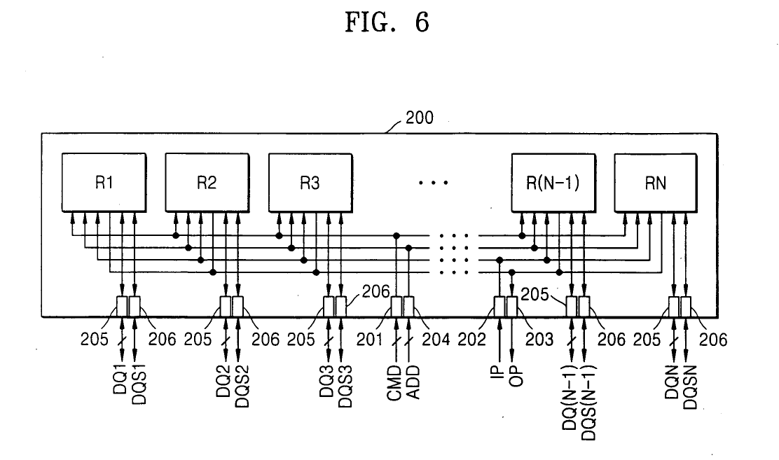

FIG. 6 is a block diagram showing a memory module 200 according to another embodiment of the present invention. Referring to FIG. 6, the memory module 200 includes a plurality of memory devices R1˜RN, a first tab 201, a second tab 202, a third tab 203, a fourth tab 204, a plurality of fifth tabs 205, and a plurality of sixth tabs 206. Each memory device R1˜RN couples to the first through fourth tabs 201˜204, a corresponding fifth tab 205, and a corresponding sixth tab 206. Although memory module 200 is shown to include one first 202˜fourth 204 tabs, in other embodiments the memory module 200 can include a plurality of first 201˜fourth 204 tabs.

Each memory device R1˜RN receives the command signal CMD through the first tab 201, an address signal ADD through the fourth tab 204, and an input parity signal IP through the second tab 202. Each memory device R1˜RN provides an output parity signal OP through the third tab 203. The number of tabs in the memory module 200, therefore, is less than in memory module 100.

Each memory device R1˜RN detects an error of the command signal CMD and the address signal ADD in response to the input parity signal IP, and provides the output parity signal OP to an external master device (not shown) as a result of the detection. Upon reception of the output parity signal OP the external master device recognizes an error occurred during transmission of the command signal CMD and the address signal ADD. Each memory device R1˜RN exchanges data signals DQ1˜DQN with the external master device through a corresponding fifth tab 205 in response to the command signal CMD and the address signal ADD, and receives clock signals DQS1˜DQSN through a corresponding sixth tabs 206. Memory devices R1˜RN operate similarly to the memory device M1 shown in FIG. 5.

As described above, the memory module of the present invention can detect error in the command signal and the address signal without including additional tabs for inputting/outputting the parity signals.

While the present invention has been particularly shown and described with reference to exemplary embodiments thereof, it will be understood by those of ordinary skill in the art that various changes in form and details may be made therein without departing from the spirit and scope of the present invention as defined by the following claims.

We claim the following:

1. A memory module comprising:
a plurality of memory devices, each memory device to receive an address signal and a command signal from a memory controller, and to detect an error in the address and command signals responsive to an input parity signal.

2. The memory module of claim 1 where each memory device is adapted to provide an output parity signal to the memory controller responsive to the detection.

3. The memory module of claim 1 where each memory device is adapted to receive the same input parity signal.

4. The memory module of claim 1 where each memory device is adapted to receive a different input parity signal.

5. The memory module of claim 1 where each memory device includes
an error detector to detect the error in the command and address signals responsive to the input parity signal;
an input buffer to provide the input parity signal to the error detector; and
an output buffer to provide an output parity signal to the memory controller responsive to the detection.

6. The memory device of claim 5 where each memory device includes
a mode set register to generate a mode control signal responsive to the address signal; and
a buffer controller to control a mode of the input and output buffers responsive to the mode control signal.

7. The memory module of claim 6 where the mode of the input and output buffers is an error detection mode.

8. The memory module of claim 6 where the mode of the input and output buffers is a data masking mode.

9. The memory module of claim 1
where each memory device includes a command decoder to generate a control signal responsive to the command signal, and a memory circuit to store data; and
where the memory circuit of at least one of the memory devices is accessed responsive to the control signal and the address signal.

10. The memory module of claim 9
where the command decoder is adapted to generate a setting control signal responsive to the command signal; and
where each memory device includes a mode set register to store the address signal responsive to the setting control signal.

11. A memory module comprising:
a first memory device to receive an address signal and a command signal, and to detect an error in the address and command signals responsive to a first input parity signal; and
a second memory device to receive the address signal and the command signal, and to detect the error in the address and command signals responsive to a second input parity signal.

12. The memory module of claim 11
where the first memory device is adapted to receive the command signal, the address signal, and the first input parity signals from a memory controller; and
where the first memory device is adapted to provide a first output parity signal to the memory controller responsive to the detection of the error.

13. The memory module of claim 11
where the second memory device is adapted to receive the command signal, the address signal, and the second input parity signals from a memory controller; and
where the second memory device is adapted to provide a second output parity signal to the memory controller responsive to the detection of the error.

14. The memory module of claim 11 where the first and second input parity signals are the same signal.

15. A method comprising:
receiving an address signal and a command signal from a memory controller; and
detecting an error in the address and command signals responsive to an input parity signal.

16. The module of claim 15 comprising providing an output parity signal to the memory controller responsive to the detection.

17. The memory module of claim 15 where detecting the error includes determining an aggregate number of signals received among the address signal, the command signal, and the input parity signal.

18. The memory device of claim 17
where the address signal includes one or more addresses;
where the command signal includes one or more commands; and
where the aggregate number is the number of addresses received in the address signal, commands received in the command signal, and the input parity signal.

19. The memory module of claim 17 comprising providing an output parity signal to the memory controller responsive to the aggregate number.

20. The memory module of claim 15
generating a control signal responsive to the command signal; and
accessing a memory circuit responsive to the control signal and the address signal.

21. The memory module of claim 15 where
generating a setting control signal responsive to the command signal; and
storing the address signal responsive to the setting control signal.
